(19) United States
(12) Patent Application Publication
(10) Pub. No.: US 2007/0216849 A1
(43) Pub. Date: Sep. 20, 2007

(54) Liquid crystal display with liquid crystal panel having light absorbing spacers adjoining thin film transistors

(75) Inventor: Zi-Sheng Pan, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/725,788

(22) Filed: Mar. 19, 2007

(30) Foreign Application Priority Data
Mar. 17, 2006 (TW) 95109297

(51) Int. Cl. G02F 1/1339

(52) U.S. Cl. 349/156

(57) ABSTRACT

An exemplary liquid crystal panel (10) includes an upper substrate (12), a lower substrate (14) located opposite to the upper substrate, a liquid crystal layer (15) located between the upper substrate and the lower substrate, and a plurality of spacers (16). The lower substrate includes a plurality of thin film transistors (145) formed thereat. The spacers adjoin top portions of the thin film transistors and extend to the upper substrate respectively. The spacers are configured for absorbing light beams passing through the thin film transistors.

### FIELD OF THE INVENTION

The present invention relates to a liquid crystal panel that includes a plurality of light absorbing spacers adjoining thin film transistors (TFTs), and a liquid crystal display (LCD) including the liquid crystal panel.

### GENERAL BACKGROUND

Liquid crystal displays are commonly used as display devices for compact electronic apparatuses, because they not only provide good quality images but are also very thin. A major component of a typical liquid crystal display is a liquid crystal panel.

Referring to FIG. 7, a typical liquid crystal panel 70 includes an upper substrate 72, a lower substrate 74 located opposite to the upper substrate 72, a liquid crystal layer 75 located between the upper substrate 72 and the lower substrate 74, and a plurality of spacers 76 (only one shown) spacing the upper substrate 72 and the lower substrate 74.

In the liquid crystal panel 70, a plurality of TFTs 77 are formed on a top surface (not labeled) of the lower substrate 74, and a plurality of black matrix units 78 are formed on a bottom surface (not labeled) of the upper substrate 72. The black matrix units 78 respectively correspond to the TFTs 77, and are separated from the TFTs 77.

Light beams passing through the TFTs 77 are liable to be scattered and thereby bypass the corresponding black matrix units 78. This can make it difficult to accurately control the gradation levels of luminance of the liquid crystal panel 70. In addition, due to inherent limitations in manufacturing of the liquid crystal panel 70, it is problematic to accurately align the black matrix units 78 with their respective TFTs 77. Therefore an area of each black matrix unit 78 generally needs to be greater than a desired minimum area, in order that the black matrix units 78 can absorb a sufficiently large amount of light beams propagating from the TFTs 77. Thus an aperture ratio of the liquid crystal panel 70 is reduced, and the optical performance of the liquid crystal panel 70 is liable to be impaired.

What is needed, therefore, is a liquid crystal panel that can overcome the above-described deficiencies. What is also needed is a liquid crystal display including the liquid crystal panel.

### SUMMARY

In one preferred embodiment, a liquid crystal panel includes an upper substrate, a lower substrate located opposite to the upper substrate, a liquid crystal layer located between the upper substrate and the lower substrate, and a plurality of first black matrix units. The lower substrate includes a plurality of thin film transistors formed thereat. The spacers adjoin top portions of the thin film transistors and extend to the upper substrate respectively. The spacers are configured for absorbing light beams passing through the thin film transistors.

Other aspects, novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is a simplified, side cross-sectional view of part of a liquid crystal panel according to a first embodiment of the present invention, the liquid crystal panel including a transparent upper substrate and a transparent lower substrate.

FIG. 2 is an abbreviated, top-down, plan view of the lower substrate of the liquid crystal panel of FIG. 1.

FIG. 3 is an abbreviated, top-down, plan view of the upper substrate of the liquid crystal panel of FIG. 1, showing color units and black matrix units located on an underside of the upper substrate and visible through the upper substrate.

FIG. 4 is an abbreviated, top-down, plan view of a transparent upper substrate of a liquid crystal panel according to a second embodiment of the present invention, showing color units and black matrix units located on an underside of the upper substrate and visible through the upper substrate.

FIG. 5 is a simplified, side cross-sectional view of part of a liquid crystal panel according to a third embodiment of the present invention.

FIG. 6 is an exploded, side-on plan view of a liquid crystal display including the liquid crystal panel of FIG. 1.

FIG. 7 is a side, cross-sectional view of part of a conventional liquid crystal panel.

### DETAILED DESCRIPTION OF PREFERRED EMBODIMENTS

Reference will now be made to the drawings to describe preferred embodiments of the present invention in detail.

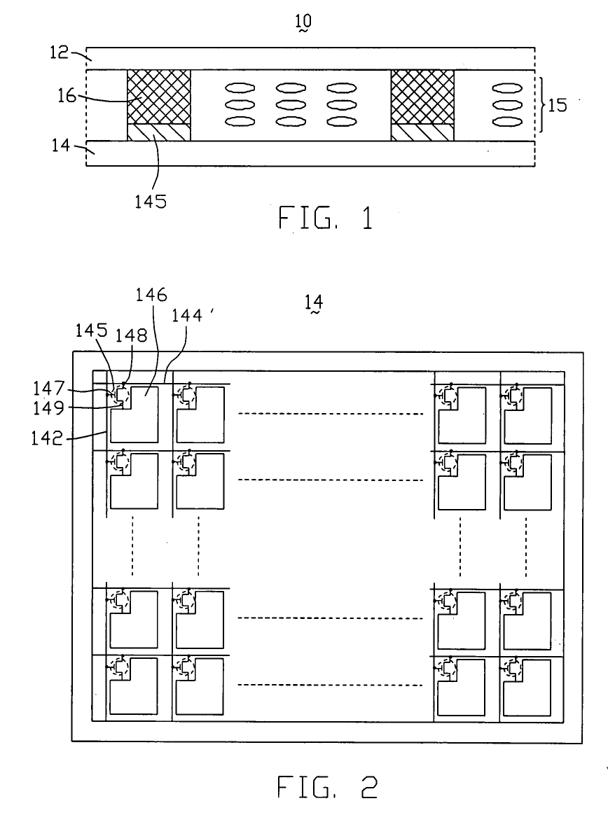

Referring to FIG. 1, a liquid crystal panel 10 according to a first embodiment of the present invention is shown. The liquid crystal panel 10 includes an upper substrate 12, a lower substrate 14 located opposite to the upper substrate 12, and a liquid crystal layer 15 located between the upper substrate 12 and the lower substrate 14. The upper substrate 12 and the lower substrate 14 are both transparent, and are generally made from glass or quartz.

Referring also to FIG. 2, the lower substrate 14 includes a plurality of scanning lines 142 that are parallel to each other and that each extend along a first direction, and a plurality of signal lines 144 that are parallel to each other and that each extend along a second direction orthogonal to the first direction. The lower substrate 14 also includes a plurality of TFTs 145 that function as switching elements. The lower substrate 14 further includes a plurality of pixel electrodes 146 formed on a surface thereof facing toward the upper substrate 12. Each TFT 145 is provided in the vicinity of a respective point of intersection of the scanning lines 142 and the signal lines 144.

Each TFT 145 includes a gate electrode 147, a source electrode 148, and a drain electrode 149. The gate electrode 147 of the TFT 145 is connected to the corresponding scanning line 142. The source electrode 148 of the TFT 145 is connected to the corresponding signal line 144. The drain electrode 149 of the TFT 145 is connected to a corresponding pixel electrode 146.

A plurality of first black matrix units 16 respectively extend from top portions (not labeled) of the TFTs 145, and reach an underside of the upper substrate 12. Each first black matrix unit 16 adjoins and covers the top portion of the respective TFT 145, and is fixed relative to the respective TFT 145. Thus, the upper substrate 12 and the lower substrate 14 are spaced from each other by the first black matrix units 16. In the illustrated embodiment, each first black matrix unit 16 has an essentially rectangular cross-sectional configuration. For example, each first black matrix unit 16 has an essentially cylindrical configuration. The first black matrix units 16 can be applied onto the respective TFTs 145 using a coating method. The first black matrix units 16 are generally made from light-sensitive black resin.

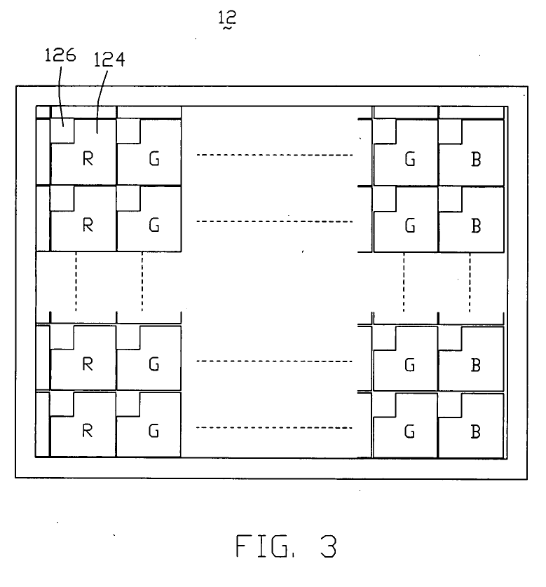

Referring also to FIG. 3, the upper substrate 12 includes a plurality of color units 124 and a plurality of second black matrix units 126 located on a bottom portion thereof. For example, the color units 124 and second black matrix units 126 are arranged on an underside of the upper substrate 12. The color units 124 are a plurality of red, green, and blue (RGB) color units arrayed in a predetermined pattern. The color units 124 respectively correspond to the pixel electrodes 146 of the lower substrate 14, and are each spaced from their neighboring color units 124 by the second black matrix units 126 to avoid color mixing. The second black matrix units 126 respectively correspond to the scanning lines 142, the signal lines 144 and the TFTs 145 on the lower substrate 14. Portions of the second black matrix units 126 contact the respective first black matrix units 16. When the liquid crystal panel 10 is manufactured, the first black matrix units 16 and the second black matrix units 126 are formed in separate processes.

With the above-described configuration, light beams passing up through the TFTs 145 can be completely absorbed by the first black matrix units 16 even when the upper substrate 12 is not aligned with the lower substrate 14 very accurately. Thus, undesired variations in gradation levels of luminance of the liquid crystal panel 10 are avoided. In addition, the first black matrix units 16 cover the respective TFTs 145, and are immobile relative to the respective TFTs 145. Thus, there is no need to align the first black matrix units 16 with the respective TFTs 145 in manufacturing of the liquid crystal panel 10. Furthermore, a distance between the upper substrate 12 and the lower substrate 14 is maintained at an essentially constant value, thus avoiding undesired optical errors in the liquid crystal panel 10.

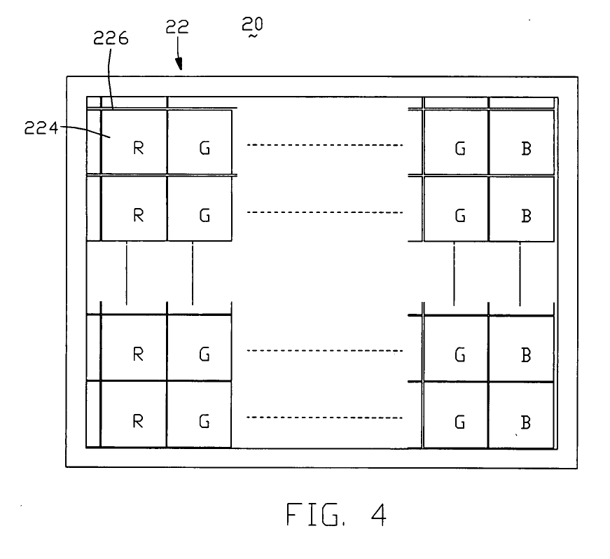

Referring to FIG. 4, a liquid crystal panel 20 according to a second embodiment of the present invention is similar to the liquid crystal panel 10. The liquid crystal panel 20 includes an upper substrate 22 having a plurality of color units 224 and a plurality of black matrix units 226 formed on an underside thereof. The black matrix units 226 space neighboring color units 224 apart from each other, in order to avoid color mixing. The black matrix units 226 respectively correspond to scanning lines (not shown) and signal lines (not shown) of a lower substrate (not shown) located opposite to the upper substrate 22 of the liquid crystal panel 20. The liquid crystal panel 20 can achieve advantages similar to those of the liquid crystal panel 10.

Referring to FIG. 5, a liquid crystal panel 30 according to a third embodiment of the present invention is similar to the liquid crystal panel 10. However, the liquid crystal panel 30 includes a plurality of first black matrix units 36 respectively adjoining a plurality of TFTs 345 formed on a lower substrate 34. Each first black matrix unit 36 has an essentially trapezoidal cross-sectional configuration. In the illustrated embodiment, each first black matrix unit 36 has an essentially isosceles trapezoidal cross-sectional configuration. For example, the first black matrix unit 36 can be frusto-conical or frusto-pyramidal. The liquid crystal panel 30 can achieve advantages similar to those of the liquid crystal panel 10.

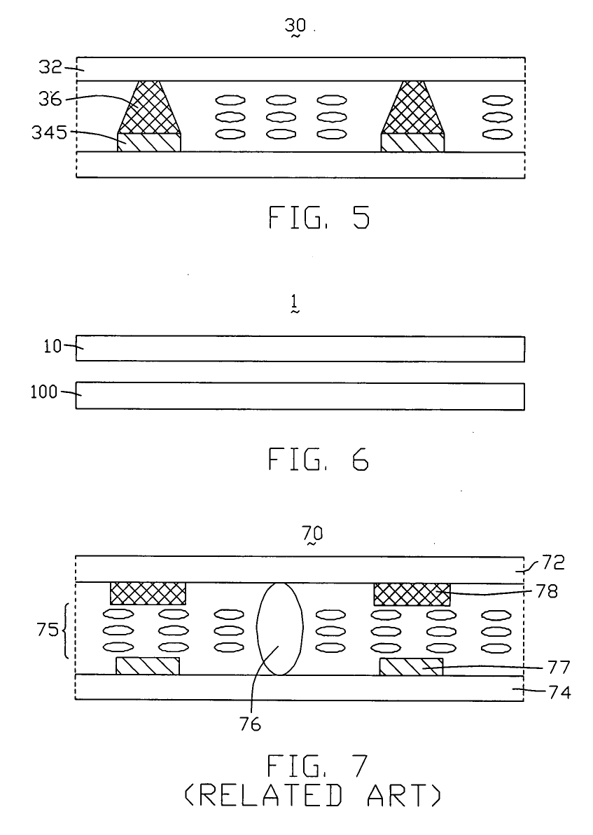

Referring to FIG. 6, a liquid crystal display 1 having the liquid crystal panel 10 is shown. The liquid crystal display 1 includes the liquid crystal panel 10 and a backlight module 100. The backlight module 100 is located adjacent to the lower substrate 14 of the liquid crystal panel 10. In alternative embodiments, the liquid crystal panel 10 can be replaced with either of the above-described liquid crystal panels 20, 30.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A liquid crystal panel comprising:
an upper substrate;
a lower substrate located opposite to the upper substrate, the lower substrate comprising a plurality of thin film transistors formed thereat;
a liquid crystal layer located between the upper substrate and the lower substrate; and
a plurality of spacers adjoining top portions of the thin film transistors respectively and extending to the upper substrate, the spacers configured for absorbing light beams passing through the thin film transistors.

2. The liquid crystal panel as claimed in claim 1, wherein the spacers completely cover the top portions of the thin film transistors.

3. The liquid crystal panel as claimed in claim 1, wherein the lower substrate further comprises a plurality of scanning lines that are parallel to each other and that each extend along a first direction, and a plurality of signal lines that are parallel to each other and that each extend along a second direction different from the first direction.

4. The liquid crystal panel as claimed in claim 3, wherein each of the thin film transistors is located in the vicinity of a respective point of intersection of the scanning lines and the signal lines.

5. The liquid crystal panel as claimed in claim 4, wherein the upper substrate comprises a plurality of color units arrayed in a predetermined pattern.

6. The liquid crystal panel as claimed in claim 5, wherein the color units comprise red, green and blue color units.

7. The liquid crystal panel as claimed in claim 5, wherein the upper substrate further comprises a plurality of black matrix units, each of the black matrix units spacing neighboring color units from each other.

8. The liquid crystal panel as claimed in claim 7, wherein each of the black matrix units corresponds to a respective one of the thin film transistors of the lower substrate.

9. The liquid crystal panel as claimed in claim 7, wherein each of the black matrix units corresponds to at least one of a respective one of the scanning lines of the lower substrate and a respective one of the signal lines of the lower substrate.

10. The liquid crystal panel as claimed in claim 7, wherein the black matrix units abut the spacers respectively.

11. The liquid crystal panel as claimed in claim 1, wherein the spacers each have an essentially rectangular cross-sectional configuration.

12. The liquid crystal panel as claimed in claim 1, wherein the spacers each have an essentially trapezoidal cross-sectional configuration.

13. The liquid crystal panel as claimed in claim 12, wherein the spacers each have an essentially isosceles trapezoidal cross-sectional configuration.

14. The liquid crystal panel as claimed in claim 1, wherein the spacers are fixed relative to their respective thin film transistors.

15. The liquid crystal panel as claimed in claim 1, wherein the spacers are coated on the thin film transistors.

16. The liquid crystal panel as claimed in claim 1, wherein the spacers are made from light-absorbing material.

17. The liquid crystal panel as claimed in claim 16, wherein the spacers are made from light-sensitive black resin.

18. A liquid crystal panel comprising:
an upper substrate;
a lower substrate located opposite to the upper substrate, the lower substrate comprising a plurality of thin film transistors formed thereat;
a liquid crystal layer located between the upper substrate and the lower substrate; and
a plurality of black matrix units adjoining top portions of the thin film transistors respectively and extending to the upper substrate.

19. A liquid crystal display comprising:
a liquid crystal panel comprising:
an upper substrate;
a lower substrate located opposite to the upper substrate, the lower substrate comprising a plurality of thin film transistors formed thereat;
a liquid crystal layer between the upper substrate and the lower substrate; and
a plurality of spacers adjoining top portions of the thin film transistors respectively and extending to the upper substrate, the spacers configured for absorbing light beams passing through the thin film transistors; and
a backlight module located adjacent to a bottom of the lower substrate.
